(19) United States
(12) Patent Application Publication
(10) Pub. No.: US 2006/0289515 A1
(43) Pub. Date: Dec. 28, 2006

(54) Meal tray with snap-fit lid that can be opened by peeling

(75) Inventors: Patrick Feuillas, Trainou (FR); Philippe Osmond, Marigny Les Usages (FR)

Correspondence Address: CASELLA & HESPOS, 274 MADISON AVENUE, NEW YORK, NY, 10016, US

(73) Assignee: International Plastic Industrie, Chilleurs Aux Bois (FR)

(21) Appl. No.: 11/447,832

(22) Filed: Jun. 6, 2006

(30) Foreign Application Priority Data
Jun. 6, 2005 (FR) 05 05699

(51) Int. Cl. H05B 6/80

(52) U.S. Cl. 219/729

(57) ABSTRACT

The present invention relates to a meal tray comprising a container (1) provided with an opening (6) designed to be closed by a lid (7) that includes an upper wall (8) and a lateral wall connected to the latter. The lid (7) can be fastened on the container (1) by snap-fitting, while its upper wall is connected to its lateral wall in a separable manner, particularly by heat-sealing, and may be removed by peeling.

### BACKGROUND OF THE INVENTION

1. Field of the Invention

The present invention relates to a meal tray comprising a container provided with an opening designed to be closed by a lid that includes an upper wall and a lateral wall connected to the latter.

2. Description of the Related Art

On trains or airplanes, meal trays are handed out to passengers so that the latter can dine while remaining in their seat. However, as the space available in front of seats is generally small, passengers often have problems opening their meal trays and thereby gaining access to the food.

Furthermore, current meal trays, after food has been placed in the containers, are closed industrially using a stretch or heat-sealable film in order to comply with hygiene regulations.

When the meal trays are closed, the containers are generally entirely surrounded by the closure film. In point of fact, fitting of this film requires complex, costly machines.

### SUMMARY OF THE INVENTION

The present invention proposes, more particularly, to remedy the above-mentioned drawbacks and, to that end, its subject is a meal tray that has the structure indicated in the first paragraph above and that is characterized in that the lid can be fastened on the container by snap-fitting, and in that its upper wall is connected to its lateral wall in a separable manner.

Users of meal trays can now open them very easily, even if they have an environmental area in which their freedom of movement is restricted. In fact, it suffices for them to remove the upper wall of the lid, which may be achieved with one hand.

Moreover, the lids may be fitted on the containers easily, manually or with the aid of a very simple machine, since this fitting is achieved by snap-fitting.

Preferably, the upper wall of the lid is connected to the lateral wall of the latter by heat-sealing and may be removed by peeling.

It is therefore appropriate in this case to exert a pulling action directed slightly upward in order to remove the upper wall of the lid and to open the meal tray.

The upper wall of the lid may also consist of a transparent sheet, in order to allow consumers to view the food contained in the meal trays.

Advantageously, the upper wall of the lid may also include a gripping tab projecting beyond the lateral wall of said lid.

Using this tab, consumers may open meal trays more easily, which greatly reduces the likelihood of tipping-over or splashing.

Preferably, the container and the lid are made from plastics.

The meal trays can thus be mass-produced by molding under very competitive financial conditions. Their weight may also be minimized, which is essential if they are to be used in airplanes.

According to a particular characteristic of the invention, the lateral wall of the lid may be shaped in order to surround at least the upper part of the lateral wall of the container.

The meal tray is thus strengthened in the vicinity of the opening of the container. It may also be closed more securely.

Advantageously, the lateral wall of the lid and the lateral wall of the container may comprise complementary securing means enabling the meal tray to be closed.

According to a preferred embodiment, the complementary securing means comprise a peripheral outer border located in the upper part of the lateral wall of the container and protuberances projecting over the inner face of the lateral wall of the lid and designed to fit under the outer border.

The meal tray can thus be closed securely.

In order to enhance the closure seal of the meal tray, the lateral wall of the lid is preferably integral with an annular element designed to axially penetrate the opening of the container and to abut against a shoulder of the lateral wall of said container when the lid closes the latter.

Furthermore, in order to facilitate fitting of the lid on the container, the annular element of the lateral wall of the lid includes an outer surface, converging toward its free end, designed to come into intimate contact with the upper part, of corresponding form, of the inner surface of the lateral wall of the container.

### BRIEF DESCRIPTION OF THE DRAWINGS

One embodiment of the present invention will be described below by way of non-limiting example, with reference to the appended drawings.

FIG. 1 is a diagrammatic perspective view of a meal tray according to the invention, the lid being shown at a distance from the container.

FIG. 2 is a plan view of the meal tray visible in FIG. 1

FIG. 3 is a partial sectional view on an enlarged scale on III-III of FIG. 2, the lid being in the closed position

FIG. 4 is a view similar to FIG. 3, but in which the lid is shown at a distance from the container.

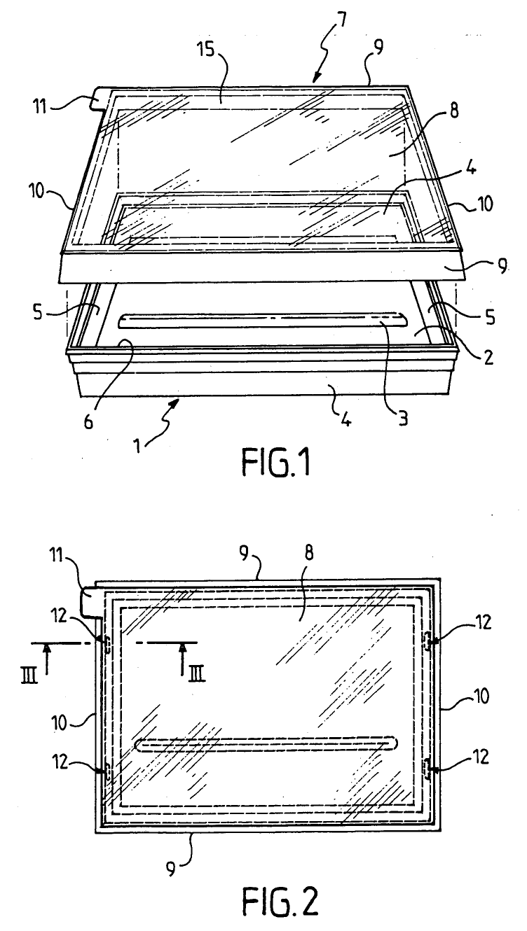

### DETAILED DESCRIPTION OF THE PREFERRED EMBODIMENTS

The meal tray that can be seen in the drawings is designed to contain and store the components of a meal that may be served on an airplane or a train.

First, it comprises a container 1 that includes a rectangular base 2 provided with a longitudinal rib 3, a lateral wall that includes two longitudinal sides 4 and two transverse sides 5, and an opening 6 delimited by the upper edge of the longitudinal sides 4 and transverse sides 5.

The meal tray also comprises a lid 7 designed to close the opening 6 of the container, this lid including an upper wall 8 connected to a lateral wall that includes two longitudinal sides 9 and two transverse sides 10.

The lid is dimensioned so that its lateral wall covers, with slight clearance, the upper part of the lateral wall of the container 1.

The upper wall 8 of the lid includes a gripping tab 11 extending beyond one of the transverse sides 10, in the vicinity of a corner of the lid.

In the embodiment envisaged here, the upper wall 8 is transparent so that consumers can view the contents of the meal tray when the latter is closed. However, nothing rules out it being impossible to see through it.

According to the invention, the upper wall 8 is connected to the upper edge of the longitudinal sides 9 and transverse sides 10 by heat-sealing, so that it can be removed by peeling.

The lateral wall and the upper wall 8 of the lid are preferably produced from plastics, which, however, is not mandatory. They could, in fact, be produced from other materials and include a heat-sealable film on their opposing faces.

In the embodiment shown, the container 1, also, is produced from plastics. However, it could be produced from another material if necessary.

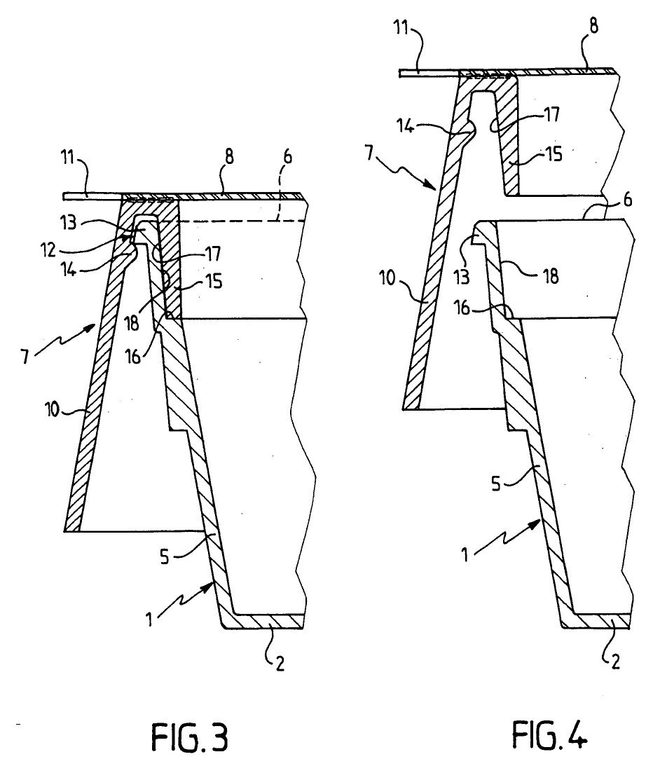

In order that the meal tray can be closed securely, the lateral walls of the container and of the lid comprise complementary securing means 12 that will now be described with reference to FIGS. 3 and 4.

As may, in fact, be seen in these figures, the securing means 12 comprise a peripheral outer border 13 located in the upper part of the lateral wall of the container 1 and protuberances 14 projecting on the inner face of the lateral wall of the lid, at a predetermined height in order that they can fit under the outer border 13 when the lid 7 is in the closed position on the container.

With reference to FIG. 2, it will be noted that the transverse sides 10 of the lateral wall of the lid each include two protuberances 14.

Naturally, however, it would not constitute a departure from the context of the present invention if the longitudinal sides 9 were also provided with protuberances or if the number of protuberances on the transverse and/or longitudinal sides was other than 2.

Returning to FIGS. 3 and 4, it will also be noted that the lateral wall of the lid 7 is integral with an annular element 15 designed to axially penetrate the opening 6 of the container 1 and to abut against a shoulder 16 of the lateral wall of said container when the lid 7 is in the closed position.

The annular element 15 includes an outer surface 17, converging toward its free end, designed to come into intimate contact with the upper part 18, of corresponding form, of the inner surface of the lateral wall of the container.

It emerges from the above description that closure of the meal tray, after the food has been placed therein, may be achieved very easily, since it suffices to insert the annular element 15 of the lid 6 until it abuts against the shoulder 16.

While the annular element approaches this position, the lateral wall of the lid deforms elastically, in effect, in order to allow the protuberances 14 to fit under the border 13 and to lock said lid on the container by means of snap-fitting.

The meal tray may also be opened very easily since it suffices to exert, on the gripping tab 11, a pulling action directed slightly upward, toward the corner of the lid diagonally opposite said tab.

The intensity of this pulling action must, of course, be sufficient for the upper wall 8 to detach itself from the lateral wall of the lid by peeling.

What is claimed is:

1. A meal tray comprising a container (1) provided with an opening (6) and a lid (7) that can be fastened by snap-fitting on the container (1) to close the opening (6) thereof, the lid (7) including a lateral wall and an upper wall (8) that are connected to one another, characterized in that the lateral wall of the lid (7) surrounds, with slight clearance, at least an upper part of the lateral wall of the container (1), and in that a link between the lateral wall and the upper wall (8) of the lid is produced by heat-sealing so that said upper wall (8) may be removed by peeling.

2. The meal tray of claim 1, wherein the upper wall (8) of the lid (7) consists of a transparent sheet.

3. The meal tray of claim 1, wherein the upper wall (8) of the lid (7) includes a gripping tab (11) projecting beyond the lateral wall of said lid (7).

4. The meal tray of claim 1, the container (1) and the lid (7) are made from plastics.

5. The meal tray of claim 1, wherein the lateral wall of the lid (7) and the lateral wall of the container (1) comprise complementary securing means (12).

6. The meal tray of claim 5, wherein the complementary securing means (12) comprise a peripheral outer border (13) located in the upper part of the lateral wall of the container (1) and protuberances (14) projecting over an inner face of the lateral wall of the lid (7) and designed to fit under the outer border (13).

7. The meal tray of claim 1, wherein in that the lateral wall of the lid (7) is integral with an annular element (15) designed to axially penetrate the opening (6) of the container (1) and to abut against a shoulder (16) of the lateral wall of said container (1) when the lid (7) closes the container (1).

8. The meal tray of claim 7, wherein the annular element (15) of the lateral wall of the lid (7) includes an outer surface (17), converging toward its free end, designed to come into intimate contact with the upper part (18), of corresponding form, of the inner surface of the lateral wall of the container (1).

9. A meal tray comprising a plastic container (1) provided with an opening (6) and a lid (7) that can be fastened by snap-fitting on the container (1) to close the opening thereof, the lid (7) including a lateral wall and an upper wall (8) that are connected to one another, the lateral wall of the lid (7) surrounding with a slight clearance, at least an upper part of the lateral wall of the container (1), a peripheral outer border (13) located in the upper part of the lateral wall of the container (1) and protuberances (14) projecting over an inner face of the lateral wall of the lid (7) and designed to fit under the outer border (13), and a link between the lateral wall and the upper wall (8) of the lid produced by heat-sealing so that said upper wall (8) may be removed by peeling.

10. The meal tray of claim 9, wherein the upper wall (8) of the lid (7) is transparent.

11. The meal tray of claim 9, wherein the upper wall (8) of the lid (7) includes a gripping tab (11) projecting beyond the lateral wall of said lid (7).

12. The meal tray of claim 9, characterized in that the lateral wall of the lid (7) is integral with an annular element (15) for axially penetrating the opening (6) of the container (1) and for abutting against a shoulder (16) of the lateral wall of said container when the lid (7) closes the container (1), the annular element (15) of the lateral wall of the lid (7) including an outer surface (17) converging toward its free end and configured for intimately contacting the upper part (18) of the inner surface of the lateral wall of the container (1).
